(19) United States
(12) Patent Application Publication
(10) Pub. No.: US 2025/0253974 A1
(43) Pub. Date: Aug. 7, 2025

(54) TRANSMISSION DEVICE, TRANSMISSION METHOD, RECEPTION DEVICE, AND RECEPTION METHOD

(71) Applicant: Sony Group Corporation, Tokyo (JP)

(72) Inventor: Kazuyuki TAKAHASHI, Chiba (JP)

(73) Assignee: Sony Group Corporation, Tokyo (JP)

(21) Appl. No.: 18/854,770

(22) PCT Filed: Apr. 27, 2023
(86) PCT No.: PCT/JP2023/016578

§ 371 Date: Oct. 7, 2024

(30) Foreign Application Priority Data
May 13, 2022 (JP) 2022-079456

(51) Int. Cl. H04L 1/00

(52) U.S. Cl. CPC H04L 1/0043

(57) ABSTRACT

There is provided a transmission device, a transmission method, a reception device, and a reception method that allow a reduction in information size of a pointer in a simpler manner. The transmission device includes: a generation unit that generates physical layer control information, the physical layer control information being included in a physical layer frame; and a transmission unit that transmits the physical layer frame as a broadcast signal to which a layered division multiplexing method is applied. The physical layer control information includes a compressed pointer obtained by compressing a pointer that indicates a position of the first error correction code block in the physical layer frame and is expressed by an integer multiple of the greatest common divisor of possible values of the pointer. The present disclosure can be applied to a transmission system compatible with a broadcasting method such as the next-generation method of the ISDB-T method, for example.

### TECHNICAL FIELD

The present disclosure relates to a transmission device, a transmission method, a reception device, and a reception method, and more particularly, to a transmission device, a transmission method, a reception device, and a reception method that allow a reduction in information size of a pointer in a simpler manner.

### BACKGROUND ART

As a broadcasting method for digital terrestrial television broadcasting, the integrated services digital broadcasting-terrestrial (ISDB-T) adopted in Japan and the like is available. In Japan, studies are being conducted to enhance the digital terrestrial television broadcasting for the next generation. As a technology related to the next-generation digital terrestrial television broadcasting, for example, a technology disclosed in Patent Document 1 is known.

In Patent Document 1, proposed is a technique using an abbreviated pointer shorter in bit length than a forward error correction (FEC) block pointer as an FEC block pointer used in a case where an integer number of FEC blocks does not fit into one orthogonal frequency division multiplexing (OFDM) frame and there is an FEC block spanning across OFDM frames. The FEC block pointer is a pointer indicating a position of the first FEC block in an OFDM frame.

### CITATION LIST

### Patent Document

Patent Document 1: Japanese Patent Application Laid-Open No. 2021-82875

### SUMMARY OF THE INVENTION

### Problems to be Solved by the Invention

In the technique using the abbreviated pointer proposed in Patent Document 1, a reception device refers to a table that maps each FEC block pointer to the corresponding abbreviated pointer for each modulation method and restores the abbreviated pointer to the FEC block pointer. It is therefore required that the reception device hold the table for each modulation method and each segment, which makes implementation complicated; therefore, a proposal for reducing an information size of a pointer in a simpler manner has been requested.

The present disclosure has been made in view of such circumstances, and it is therefore an object of the present disclosure to allow a reduction in information size of a pointer in a simpler manner.

### Solutions to Problems

A transmission device according to one aspect of the present disclosure includes: a generation unit that generates physical layer control information, the physical layer control information being included in a physical layer frame; and a transmission unit that transmits the physical layer frame as a broadcast signal to which a layered division multiplexing method is applied, in which the physical layer control information includes a compressed pointer obtained by compressing a pointer that indicates a position of the first error correction code block in the physical layer frame and is expressed by an integer multiple of the greatest common divisor of possible values of the pointer.

A transmission method according to one aspect of the present disclosure includes: causing a transmission device to generate physical layer control information, the physical layer control information being included in a physical layer frame; and causing the transmission device to transmit the physical layer frame as a broadcast signal to which a layered division multiplexing method is applied, in which the physical layer control information includes a compressed pointer obtained by compressing a pointer that indicates a position of the first error correction code block in the physical layer frame and is expressed by an integer multiple of the greatest common divisor of possible values of the pointer.

In the transmission device and the transmission method according to one aspect of the present disclosure, the physical layer control information included in the physical layer frame is generated, and the physical layer frame is transmitted as a broadcast signal to which the layered division multiplexing method is applied. Furthermore, the physical layer control information includes a compressed pointer obtained by compressing a pointer that indicates the position of the first error correction code block in the physical layer frame and is expressed by an integer multiple of the greatest common divisor of possible values of the pointer.

A reception device according to one aspect of the present disclosure includes a reception unit that receives a physical layer frame transmitted as a broadcast signal to which a layered division multiplexing method is applied, in which the physical layer frame includes physical layer control information including a compressed pointer obtained by compressing a pointer that indicates a position of the first error correction code block in the physical layer frame and is expressed by an integer multiple of the greatest common divisor of possible values of the pointer, and the reception unit performs error correction decoding for each error correction code block included in the physical layer frame on the basis of the compressed pointer obtained from the physical layer control information.

A reception method according to one aspect of the present disclosure includes causing a reception device to receive a physical layer frame transmitted as a broadcast signal to which a layered division multiplexing method is applied, in which the physical layer frame includes physical layer control information including a compressed pointer obtained by compressing a pointer that indicates a position of the first error correction code block in the physical layer frame and is expressed by an integer multiple of the greatest common divisor of possible values of the pointer, and error correction decoding is performed for each error correction code block included in the physical layer frame on the basis of the compressed pointer obtained from the physical layer control information.

In the reception device and the reception method according to one aspect of the present disclosure, the physical layer frame transmitted as a broadcast signal to which the layered division multiplexing method is applied is received, and the physical layer control information is included in the physical layer frame, the physical layer control information including a compressed pointer obtained by compressing a pointer that indicates the position of the first error correction code block in the physical layer frame and is expressed by an integer multiple of the greatest common divisor of possible values of the pointer. Furthermore, the error correction decoding is performed for each error correction code block included in the physical layer frame on the basis of the compressed pointer obtained from the physical layer control information.

Note that the transmission device and the reception device according to one aspect of the present disclosure may be independent devices or may be internal blocks constituting one device.

### BRIEF DESCRIPTION OF DRAWINGS

FIG. 1 is a block diagram illustrating a configuration example of an embodiment of a transmission system to which the present disclosure is applied.

FIG. 2 is a block diagram illustrating a configuration example of a transmission device in FIG. 1.

FIG. 3 is a block diagram illustrating a configuration example of a reception device in FIG. 1.

FIG. 4 is a diagram illustrating a relationship between an OFDM frame and an FEC block.

FIG. 5 is a diagram schematically illustrating transmission of broadcast signals under a layered division multiplexing method.

FIG. 6 is a diagram schematically illustrating transmission of broadcast signals under the layered division multiplexing method.

FIG. 7 is a diagram illustrating examples of bit allocation of TMCC information.

FIG. 8 is a diagram illustrating an example of a flag indicating that there is a new broadcast.

FIG. 9 is a diagram illustrating an example of a compressed pointer of the new broadcast.

FIG. 10 is a diagram illustrating an example of the number of segments of the new broadcast.

FIG. 11 is a diagram illustrating an example of an instruction to place an adjustment band of the new broadcast.

FIG. 12 is a flowchart illustrating a flow of processing of each device in the transmission system.

FIG. 13 is a block diagram illustrating a configuration example of a computer.

### MODE FOR CARRYING OUT THE INVENTION

### <System Configuration>

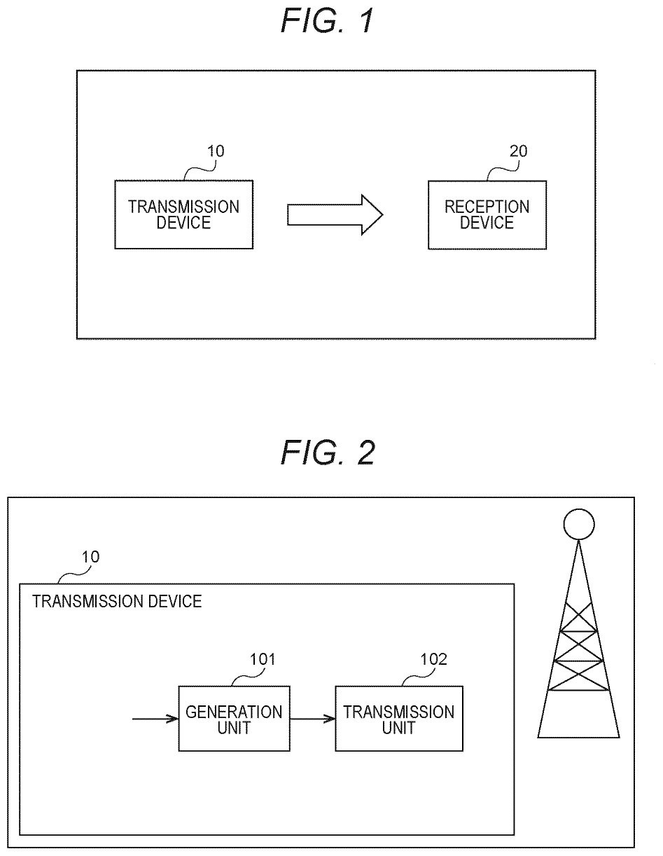

FIG. 1 is a block diagram illustrating a configuration example of an embodiment of a transmission system to which the present disclosure is applied.

In FIG. 1, the transmission system includes a transmission device 10 and a reception device 20. Note that the system is a logical assembly of a plurality of devices.

The transmission device 10 is a device that transmits, as a broadcast signal, content such as a broadcast program or a commercial (CM) produced by a terrestrial broadcasting station. The transmission device 10 generates a broadcast stream, performs necessary processing on the stream, and transmits the resulting broadcast signal of digital terrestrial television broadcasting (hereinafter, referred to as terrestrial broadcast signal) from a transmission antenna installed in a transmission station.

The reception device 20 is a device capable of receiving a broadcast signal, such as a television receiver or a set top box (STB). The reception device 20 receives the terrestrial broadcast signal transmitted from the transmission device 10 via an antenna. The reception device 20 performs necessary processing on the broadcast stream obtained from the received terrestrial broadcast signal and outputs the resulting video and audio of content such as a broadcast program.

FIG. 2 is a block diagram illustrating a configuration example of the transmission device 10 in FIG. 1. In FIG. 2, the transmission device 10 includes a generation unit 101 and a transmission unit 102.

The generation unit 101 generates control information such as transmission control information on the basis of data input to the generation unit 101. In the following description, control information transmitted at the physical layer is also referred to as physical layer control information in order to be distinguished from control information (for example, upper layer control information regarding a broadcast component) transmitted at an upper layer (for example, a transport layer), which is higher than the physical layer.

The generation unit 101 performs necessary processing on the broadcast stream input to the generation unit 101 and adds the generated physical layer control information to generate a physical layer frame conforming to the broadcasting method of digital terrestrial television broadcasting, and supplies the physical layer frame to the transmission unit 102.

The broadcast stream includes a broadcast component constituting content such as a broadcast program produced by a terrestrial broadcasting station, and upper layer control information regarding the broadcast component. The broadcast component includes components such as a video stream, an audio stream, and a subtitle stream.

The transmission unit 102 performs necessary processing such as modulation processing on the physical layer frame supplied from the generation unit 101, and transmits the resulting terrestrial broadcast signal from the transmission antenna.

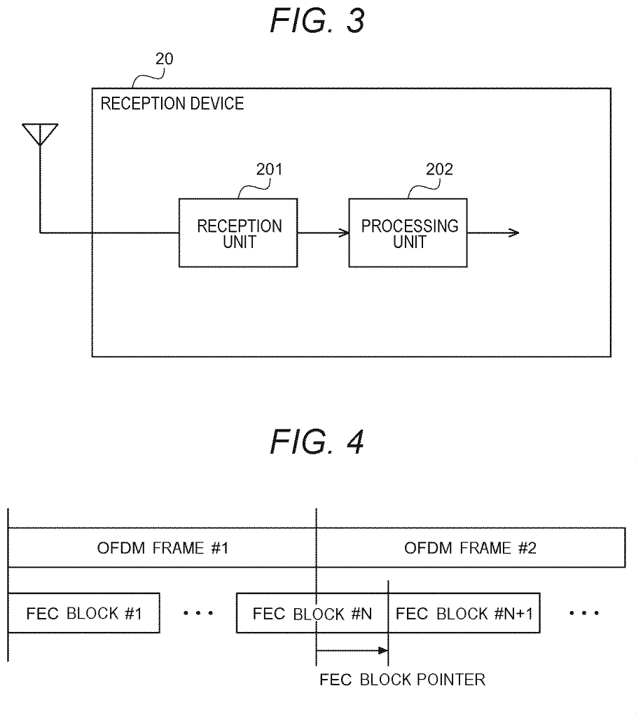

FIG. 3 is a block diagram illustrating a configuration example of the reception device 20 in FIG. 1. In FIG. 3, the reception device 20 includes a reception unit 201 and a processing unit 202.

The reception unit 201 includes a tuner, a demodulation large scale integration (LSI), or the like. The reception unit 201 performs necessary processing such as demodulation processing on the terrestrial broadcast signal received via the antenna to acquire the physical layer control information included in the physical layer frame. The reception unit 201 performs necessary processing on the signal obtained from the physical layer frame on the basis of the acquired physical layer control information, and supplies a packet storing data of the resulting broadcast stream to the processing unit 202.

The processing unit 202 includes a main system on chip (SoC) or the like. The processing unit 202 performs necessary processing such as decoding processing and reproduction processing on the packet supplied from the reception unit 201.

Since the broadcast stream includes the broadcast component and the upper layer control information, in the decoding processing and the reproduction processing, data of the broadcast component is decoded and reproduced on the basis of the upper layer control information. Data such as video and audio obtained as a result of the decoding processing and the reproduction processing is output to a subsequent circuit. As a result, in the reception device 20, the video of content such as a broadcast program is output on a display, and the audio synchronized with the video is output from a speaker.

Note that the above-described configuration in FIG. 1 has been given as an example where one reception device 20 is provided, but actually, a plurality of reception devices 20 can be provided, and each can receive and process the terrestrial broadcast signal transmitted from the transmission device 10. Furthermore, the above-described configuration in FIG. 2 has been given as a configuration where the transmission device 10 includes the generation unit 101 and the transmission unit 102, or alternatively, the generation unit 101 and the transmission unit 102 may be provided in different devices. That is, the configuration illustrated in FIG. 2 may be a transmission system including a first device that includes the generation unit 101 and a second device that includes the transmission unit 102.

### <FEC Block Pointer>

In the above-described configuration, for example, a broadcasting method such as integrated services digital broadcasting-terrestrial (ISDB-T) can be used as the broadcasting method of digital terrestrial television broadcasting. Furthermore, although ISDB-T is adopted in Japan, the next-generation method of digital terrestrial television broadcasting has been studied. In the above-described configuration, the next-generation method (hereinafter, referred to as broadcasting method of the new broadcast, hereinafter, also referred to as new broadcasting method) of ISDB-T can be used as the broadcasting method of digital terrestrial television broadcasting. The current ISDB-T is a broadcasting method of the existing broadcast, and can also be said to be an existing broadcasting method.

For the new broadcasting method, an orthogonal frequency division multiplexing (OFDM) method is used in a manner similar to the existing broadcasting method, and studies are being conducted to apply a low density parity check (LDPC) code as an error correction code. The LDPC code is a block code with a fixed code length, and an LDPC code block as an error correction code block is hereinafter referred to as forward error correction (FEC) block.

Furthermore, studies are being conducted to apply a layered division multiplexing (LDM) method as a multiplexing method of broadcast signals to transmission of broadcast signals of the new broadcasting method.

In the broadcast signals of the new broadcasting method transmitted under the layered division multiplexing method, the code length of the LDPC code and the structure of the physical layer frame (the OFDM frame of the ISDB-T frame) are not integer multiples of each other; therefore, the FEC block is transmitted with the FEC block placed across one OFDM frame. For example, in a case where a 69 k LDPC code is used, the structure of the ISDB-T frame is represented by 8 k FFT 384 (data carrier)×13 (segment)×204 (symbol), and thus, the code length (69120 bits) of the 69 k LDPC code and the structure of the ISDB-T frame are not integer multiples of each other.

FIG. 4 is a diagram illustrating a relationship between the OFDM frame and the FEC block. In FIG. 4, an OFDM frame #1 and an OFDM frame #2 are temporally consecutive frames, and each include a plurality of FEC blocks. The OFDM frame #1 includes a plurality of FEC blocks from an FEC block #1 to a part of an FEC block #N. The OFDM frame #2 includes a plurality of FEC blocks including the remaining part of the FEC block #N and the next FEC block #N+1. That is, the FEC block #N is placed across the OFDM frame #1 and the OFDM frame #2.

In the reception device 20, when the reception unit 201 performs the demodulation processing, it is necessary to identify a boundary (break) between FEC blocks in the OFDM frame in order to process data included in the OFDM frame for each FEC block. The reception unit 201 can extract an FEC block appropriately by using an FEC block pointer indicating the position of the first FEC block in the OFDM frame.

Here, a pointer (hereinafter, referred to as compressed pointer) obtained by compressing the FEC block pointer is used so as to reduce a size of information used to transmit the FEC block pointer and facilitate restoration to the FEC block pointer. The compressed pointer can be expressed by an integer multiple of the greatest common divisor of possible values of the FEC block pointer.

For example, in a case where an LDPC code with a code length of 69120 (69 k) bits is used, and quadrature phase shift keying (QPSK) is used as the modulation method, the maximum value of the FEC block pointer becomes 69120/2=34560. At this time, since the greatest common divisor of possible values of the FEC block pointer is 576, 34560/576=60, and the compressed pointer can be expressed in 6 bits.

It is possible to reduce, by expressing the compressed pointer as an integer multiple of 576, which is the greatest common divisor of possible values of the FEC block pointer, the size of information used to transmit the FEC block pointer. Furthermore, the fact that the compressed pointer can be expressed as an integer multiple of the greatest common divisor (576) eliminates the need of a table used to restore the compressed pointer to the FEC block pointer, prevents the implementation of the reception device 20 from becoming complicated, and enables the implementation with a simpler configuration.

In Patent Document 1 described above, focusing on the fact that the FEC block pointer has only 15 different values regardless of the number of segments, proposed is a transmission device that generates a TMCC signal including an abbreviated pointer shorter in bit length than the FEC block pointer. In Patent Document 1 described above, further proposed is that a reception device holds a table that maps each FEC block pointer to the corresponding abbreviated pointer for each modulation method, and refers to the table to restore the abbreviated pointer obtained from the TMCC signal to the FEC block pointer.

The technique proposed in Patent Document 1 described above, however, has the following problems. That is, it is required that the reception device hold a table for each modulation method and each segment, which makes implementation complicated. For example, in a case where the number of segments is 13, it is necessary to hold values for every 28 combinations. Moreover, when the number of segments becomes 12 to 1, these values change, and it is thus necessary to hold values (table) for each segment and each modulation method.

On the other hand, in the transmission system to which the present disclosure is applied, the transmission device 10 transmits the compressed pointer expressed by an integer multiple of the greatest common divisor (576) of possible values of the FEC block pointer, so that it is possible to implement the function of the compressed pointer without the need for the reception device 20 to hold a table used for restoration to the FEC block pointer. Such an implementation allows a reduction in size of information used to transmit the FEC block pointer and further prevents the implementation from becoming complicated. That is, the transmission system to which the present disclosure is applied achieves a compressed pointer that is easy for the reception device 20 to restore.

### <Number of Segments>

With the configuration described above, in a case where the layered division multiplexing method (LDM method) is used, broadcast signals can be transmitted at a high power layer as an upper layer (UL) and a low power layer as a lower layer (LL). For example, it is assumed that a broadcast signal compatible with the existing broadcasting method (ISDB-T) is transmitted at the high power layer (UL), and a broadcast signal of the new broadcasting method (next-generation method of ISDB-T) is transmitted at the low power layer (LL).

Specifically, a broadcast signal including 2K content corresponding to 2K video is transmitted at the high power layer (UL), and a video signal including 4K content corresponding to 4K video is transmitted at the low power layer (LL), so that transmission of broadcast signals of 2K and 4K broadcasts becomes possible. As a result, in a case where the reception device 20 is compatible with the new broadcasting method, the 4K content can be viewed, and even in a case where the reception device 20 is not compatible with the new broadcasting method, the 2K content can be viewed.

In the layered division multiplexing method, radio waves with different levels are superimposed and transmitted in the same frequency band, but it is known that the low power layer (LL) interferes with the high power layer (UL). Therefore, in a case where a broadcast signal compatible with the existing broadcast (hereinafter, also referred to as broadcast signal of the existing broadcast) is transmitted at the high power layer (UL), and a broadcast signal of the new broadcast is transmitted at the low power layer (LL), the broadcast signal of the new broadcast may interfere with the broadcast signal of the existing broadcast.

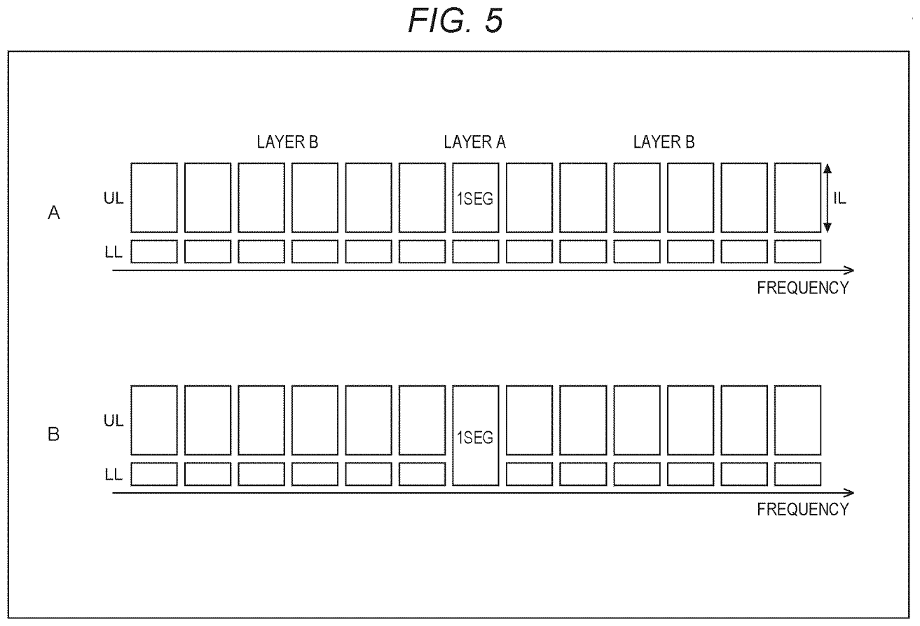

FIG. 5 is a diagram schematically illustrating transmission of broadcast signals under the layered division multiplexing method. A and B of FIG. 5 illustrate that, when a vertical axis represents a signal level (output level), and a horizontal axis represents a frequency, 12 segments out of 13 segments are used in broadcasting for fixed receivers, and the remaining one segment is used in broadcasting for mobile receivers (so-called 1seg broadcasting).

In A of FIG. 5, a combination of the upper rectangle corresponding to the high power layer (UL) and the lower rectangle corresponding to the low power layer (LL) corresponds to each segment, and one center segment serving as a layer A is used in broadcasting for mobile receivers. Furthermore, each of the six segments on either side of one center segment becomes a layer B and is used in broadcasting for fixed receivers. In the drawing, an injection level (IL) represents an input level of the lower layer (LL).

Under the method illustrated in A of FIG. 5, it is possible to solve, by changing the modulation method of the broadcast signal of the existing broadcast transmitted at the high power layer (UL) of the layer B to a more robust transmission parameter, the problem of interference from the low power layer (LL) of the layer B to the high power layer (UL), that is, interference from the broadcast signal of the new broadcast to the broadcast signal of the existing broadcast.

On the other hand, for the layer A, it is necessary to ensure a bitrate required to implement a broadcasting service for mobile receivers, and it is thus difficult to make the modulation method of the broadcast signal of the existing broadcast transmitted at the high power layer (UL) more robust. Therefore, the method illustrated in A of FIG. 5 cannot solve the problem of interference from the low power layer (LL) of the layer A to the high power layer (UL), that is, interference from the broadcast signal of the new broadcast to the broadcast signal of the existing broadcast.

In B of FIG. 5, in a manner similar to A of FIG. 5, a combination of the upper rectangle corresponding to the high power layer (UL) and the lower rectangle corresponding to the low power layer (LL) corresponds to each segment, but B of FIG. 5 is different in segment configuration of the layer A from A of FIG. 5. That is, under the method illustrated in B of FIG. 5, the broadcast signal of the existing broadcast is transmitted without the low power layer (LL) used to transmit the broadcast signal of the new broadcast placed in the frequency band corresponding to the layer A.

As described above, under the method illustrated in B of FIG. 5, since the broadcast signal of the new broadcast is not transmitted at the layer A, there is no possibility of interference with the broadcast signal of the existing broadcast, and it is therefore possible to solve the problem of interference from the broadcast signal of the new broadcast to the broadcast signal of the existing broadcast. Furthermore, under the method illustrated in B of FIG. 5, in a manner similar to the method illustrated in A of FIG. 5, it is possible to solve, by changing the modulation method of the broadcast signal of the existing broadcast transmitted at the high power layer (UL) of the layer B to a more robust transmission parameter, the problem of interference from the broadcast signal of the new broadcast to the broadcast signal of the existing broadcast. That is, the method illustrated in B of FIG. 5 corresponds to a case where the layered division multiplexing method is applied to the layer B.

Therefore, the method illustrated in B of FIG. 5 can solve, for both the layer A and the layer B, the problem of interference from the broadcast signal of the new broadcast to the broadcast signal of the existing broadcast, and can prevent deterioration in reception characteristics. As described above, making the number of segments used for the new broadcast variable allows the new broadcast to use various numbers of segments and thus allows for more flexible operation.

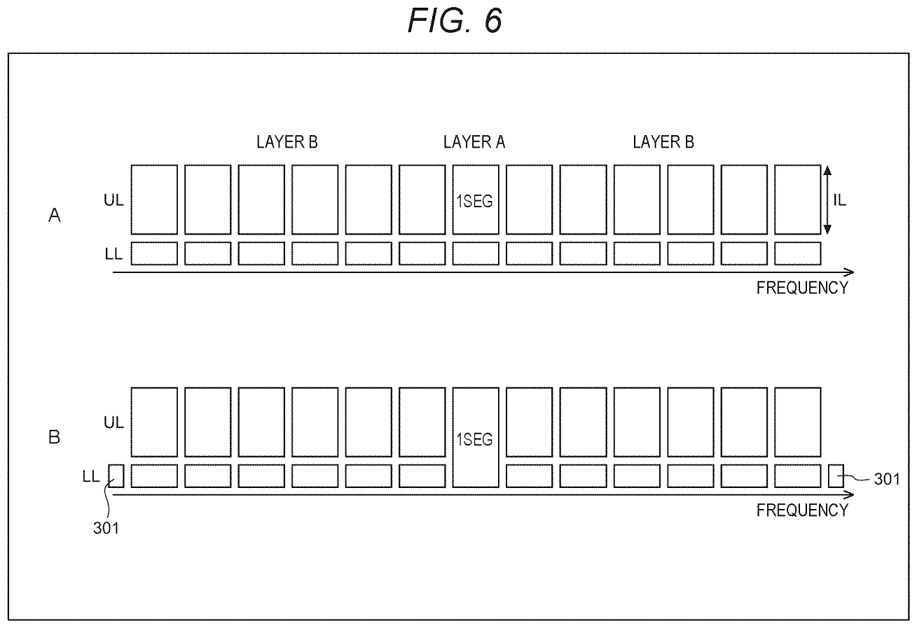

Under the method illustrated in B of FIG. 5, since the low power layer (LL) used to transmit the broadcast signal of the new broadcast is not placed in the frequency band corresponding to the layer A, the number of segments used to transmit the broadcast signal of the new broadcast decreases. Such a decrease in the number of segments directly leads to a decrease in volume of data (transmission capacity) that can be transmitted on the broadcast signal of the new broadcast, so that a method as illustrated in B of FIG. 6 may be used, for example.

Under the method illustrated in B of FIG. 6, in order to prevent interference between adjacent broadcast signals, an adjustment band 301 is placed in a guard band (guard frequency) provided between frequency bands in use, and the broadcast signal of the new broadcast is transmitted. Since it is possible to increase the transmission capacity by transmission of the broadcast signal of the new broadcast in the adjustment band 301 placed in the guard band, it is possible to make the transmission capacity used to transmit the broadcast signal of the new broadcast large enough even in a case where the low power layer (LL) is not placed in the frequency band corresponding to the layer A.

### <Physical Layer Control Information>

Furthermore, in ISDB-T, a transmission multiplexing configuration control (TMCC) signal is defined as the physical layer control information (transmission control information). The TMCC signal includes transmission parameters such as a modulation method of each layer and an error correction coding rate. It is possible to transmit parameters such as the above-described compressed pointer, the number of segments used for the new broadcast, and an instruction to place the adjustment band with the parameters included in the TMCC signal.

Among 204 bits B₀ to B₂₀₃ of a TMCC carrier, a demodulation reference signal for TMCC symbol is assigned to the bit B₀, a synchronization signal is assigned to the bits B₁ to B₁₆, segment format identification is assigned to the bits B₁₇ to B₁₉, TMCC information is assigned to the bits B₂₀ to B₁₂₁, and a parity bit is assigned to the bits B₁₂₂ to B₂₀₃.

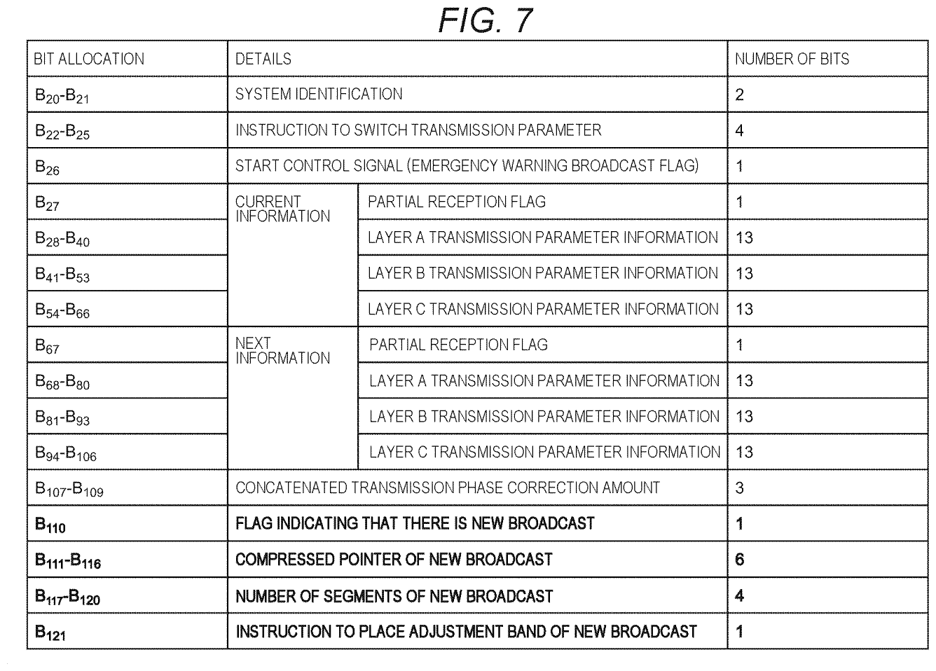

FIG. 7 is a diagram illustrating examples of bit allocation of the TMCC information. As illustrated in FIG. 7, among the bits B₂₀ to B₁₂₁ of the TMCC information, system identification is assigned to the bits B₂₀ to B₂₁, a transmission parameter switching index is assigned to the bits B₂₂ to B₂₅, a start control signal is assigned to the bit B₂₆, current information is assigned to the bits B₂₇ to B₆₆, next information is assigned to the bits B₆₇ to B₁₀₆, and a concatenated transmission phase correction amount is assigned to the bits B₁₀₇ to B₁₀₉. The bits B₁₁₀ to B₁₂₁ are undefined in ISDB-T, and are allocated to parameters related to a new broadcast.

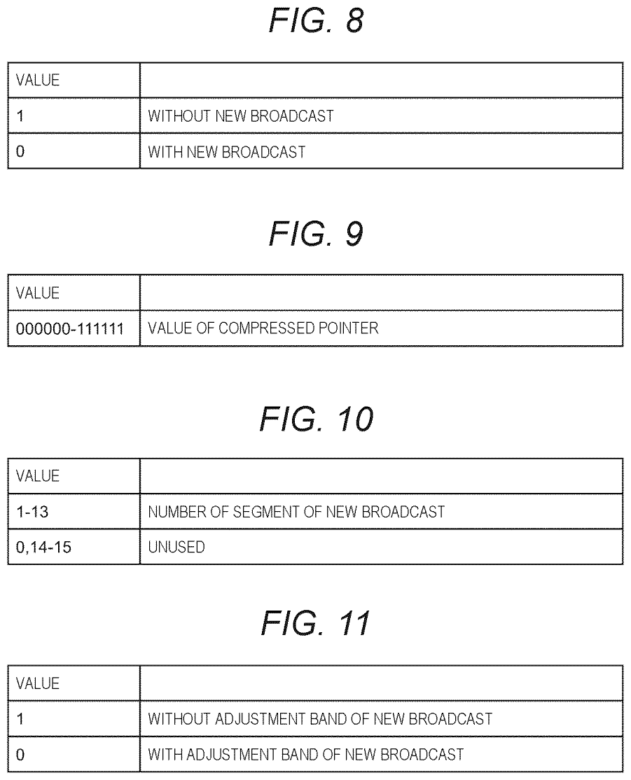

A flag indicating that there is a new broadcast is assigned to the bit Biro. FIG. 8 illustrates an example of the flag indicating that there is a new broadcast. As illustrated in FIG. 8, the bit B₁₁₀ set to a value of ‘1’ indicates that no new broadcast is being transmitted. The bit B₁₁₀ set to a value of ‘0’ indicates that a new broadcast is being transmitted.

A compressed pointer (compressed pointer of the new broadcast) used in processing for the broadcast signal of the new broadcast is assigned to the six bits of the bits B₁₁₁ to B₁₁₆. FIG. 9 illustrates an example of the compressed pointer of the new broadcast. As illustrated in FIG. 9, the six bits of the bits B₁₁₁ to B₁₁₆ are set to a value of the compressed pointer.

The number of segments used for the new broadcast (the number of segments of the new broadcast) is assigned to the four bits of the bits B₁₁₇ to B₁₂₀. FIG. 10 illustrates an example of the number of segments of the new broadcast. As illustrated in FIG. 10, the four bits of the bits B₁₁₇ to B₁₂₀ are set to any value of 1 to 13 as the number of segments of the new broadcast. Values of 0, 14, and 15 that can be set to the four bits of the bits B₁₁₇ to B₁₂₀ are unused.

The instruction to place the adjustment band of the new broadcast is assigned to the bit B₁₂₁. FIG. 11 illustrates an example of the instruction to place the adjustment band of the new broadcast. As illustrated in FIG. 11, the bit B₁₂₁ set to ‘1’ indicates that the adjustment band of the new broadcast is not placed in the guard band. The bit B₁₂₁ set to ‘0’ indicates that the adjustment band of the new broadcast is placed in the guard band.

Note that it is possible to transmit parameters such as the flag indicating that there is a new broadcast, the compressed pointer of the new broadcast, the number of segments of the new broadcast, and the instruction to place the adjustment band of the new broadcast with the parameters included in an auxiliary channel (AC) signal as defined by ISDB-T.

### <Flow of Processing of Each Device>

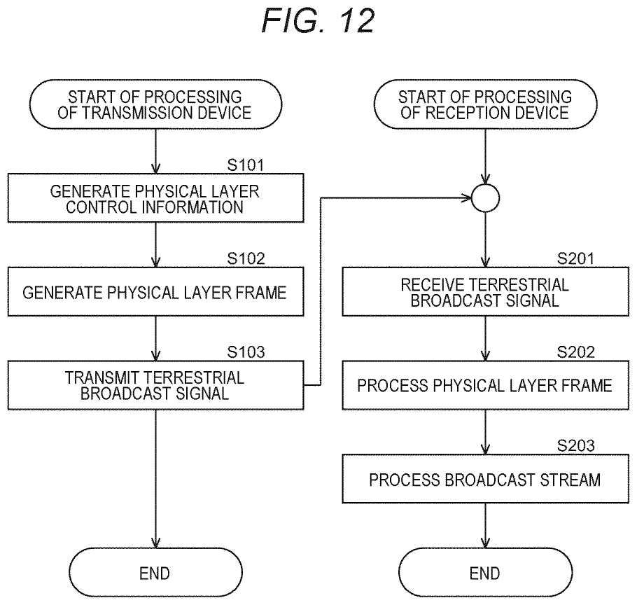

Next, a flow of processing of each device in the transmission system will be described with reference to a flowchart in FIG. 12.

First, processing of steps S101 to S103 performed by the transmission device 10 will be described. In step S101, the generation unit 101 generates physical layer control information. For example, the physical layer control information is a TMCC signal and includes parameters related to a new broadcast such as a compressed pointer, the number of segments, and an instruction to place an adjustment band.

In step S102, the generation unit 101 generates a physical layer frame including the physical layer control information. In step S103, the transmission unit 102 performs necessary processing on the physical layer frame and transmits the resulting physical layer frame as a terrestrial broadcast signal from the transmission antenna. For example, the physical layer frame is an OFDM frame including FEC blocks. As a multiplexing method of broadcast signals, a layered division multiplexing method is used.

Next, processing of steps S201 to S203 performed by the reception device 20 will be described. In step S201, the reception unit 201 receives the terrestrial broadcast signal transmitted from the transmission device 10 via the antenna.

In step S202, the reception unit 201 processes the physical layer frame obtained from the terrestrial broadcast signal. When processing the signal obtained from the physical layer frame, processing using the physical layer control information is performed. For example, the physical layer control information is a TMCC signal including parameters related to the new broadcast such as a compressed pointer, the number of segments, and an instruction to place an adjustment band.

For example, the reception unit 201 performs error correction decoding for each FEC block included in the OFDM frame on the basis of the compressed pointer obtained from the TMCC signal. At this time, even in a case where the FEC block is placed across one OFDM frame, it is possible to identify the position of the first FEC block in each OFDM frame by using an FEC block pointer restored from the compressed pointer, so that the processing can be performed for each FEC block. Furthermore, since the compressed pointer is a pointer obtained by compressing a pointer expressed by an integer multiple of the greatest common divisor of possible values of the FEC block pointer, the compressed pointer can be restored to the FEC block pointer without using a table.

Furthermore, the reception unit 201 can recognize the number of segments of the new broadcast to be transmitted at the low power layer (LL) under the layered division multiplexing method on the basis of the number of segments obtained from the TMCC signal, and perform processing in accordance with the recognition result. The reception unit 201 can recognize whether or not the adjustment band is placed in the guard band on the basis of the instruction to place the adjustment band obtained from the TMCC signal, and perform processing in accordance with the recognition result.

In step S203, the processing unit 202 processes a packet storing data of the broadcast stream. Here, in the decoding processing and the reproduction processing, data of the broadcast component is decoded and reproduced. As a result, in the reception device 20, the video of content such as a broadcast program is output on a display, and the audio synchronized with the video is output from a speaker.

### <Modification>

In the above description, the ISDB-T method has been described as the broadcasting method of digital terrestrial television broadcasting, but the present disclosure may be applied to other broadcasting methods. Furthermore, the present technology may be applied to not only a broadcasting method using terrestrial signals (terrestrial broadcasting) but also a broadcasting method using, for example, broadcasting satellites (BS) or communications satellites (CS), or wired broadcasting using cables (common antenna television (CATV)).

In the above description, the reception device 20 has been described as a fixed receiver such as a television receiver or a set top box (STB), but examples of the fixed receiver may include electronic devices such as a recorder, a game console, and a personal computer (PC). Moreover, the reception device 20 is not limited to the fixed receiver, and may include an electronic device, for example, a mobile receiver such as a smartphone, a mobile phone, or a tablet computer, an in-vehicle device mounted on a vehicle such as an in-vehicle television receiver, a wearable computer such as a head mounted display (HMD), or the like.

Furthermore, in the transmission system to which the present disclosure is applied, a server with various functions connected to a communication line such as the Internet is provided, and the reception device 20 having a communication function may access the server via the communication line to perform interactive communication, and receive and process various data such as content or applications.

Herein, the “2K video” is video corresponding to a screen resolution of approximately 1920×1080 pixels, and the “4K video” is video corresponding to a screen resolution of approximately 3840×2160 pixels. Furthermore, in the above description, 2K content of the 2K video transmitted as the existing broadcast and 4 K content of the 4K video transmitted as the new broadcast have been described as content; however, as the new broadcast, higher quality content such as 8K video may be transmitted. The “8K video” is video corresponding to a screen resolution of approximately 7680×4320 pixels.

Furthermore, the terms used herein are merely examples, and the use of other terms is not intentionally excluded. For example, in the above description, the “compressed pointer” may be replaced with another term such as “abbreviated pointer”.

### <Configuration of Computer>

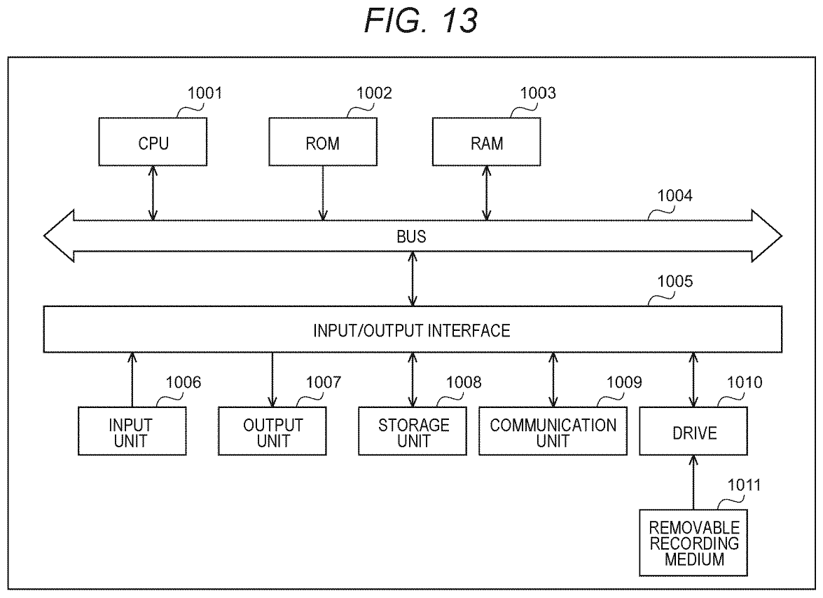

The series of processing described above can be performed by hardware or software. In a case where the series of processing is performed by the software, a program constituting the software is installed on a computer. FIG. 13 is a block diagram illustrating a configuration example of the hardware of the computer that performs the above-described series of processing in accordance with the program.

In the computer, a central processing unit (CPU) 1001, a read only memory (ROM) 1002, and a random access memory (RAM) 1003 are mutually connected by a bus 1004. The bus 1004 is further connected with an input/output interface 1005. An input unit 1006, an output unit 1007, a storage unit 1008, a communication unit 1009, and a drive 1010 are connected to the input/output interface 1005.

The input unit 1006 includes a keyboard, a mouse, a microphone, or the like. The output unit 1007 includes a display, a speaker, or the like. The storage unit 1008 includes a hard disk, a non-volatile memory, or the like. The communication unit 1009 includes a network interface or the like. The drive 1010 drives a removable recording medium 1011 such as a semiconductor memory, a magnetic disk, an optical disc, or a magneto-optical disk.

In the computer configured as described above, the CPU 1001 loads a program recorded in the ROM 1002 or the storage unit 1008 into the RAM 1003 via the input/output interface 1005 and the bus 1004 and executes the program, so as to perform the above-described series of processing.

A program executed by the computer (CPU 1001) can be provided by being recorded on the removable recording medium 1011 as a package medium, or the like, for example. Furthermore, the program can be provided via a wired or wireless transmission medium such as a local area network, the Internet, or digital broadcasting.

In the computer, the program can be installed in the storage unit 1008 via the input/output interface 1005 with the removable recording medium 1011 attached to the drive 1010. Furthermore, the program can be received by the communication unit 1009 via a wired or wireless transmission medium and installed in the storage unit 1008. Alternatively, the program can be installed in the ROM 1002 or the storage unit 1008 in advance.

Herein, the processing to be performed by the computer in accordance with the program is not necessarily performed on a time-series basis according to the sequence described in the flowchart. In other words, the processing to be performed by the computer in accordance with the program includes processing to be performed in parallel or independently (for example, parallel processing or object-based processing). Furthermore, the program may be executed by one computer (processor), or may be executed by a plurality of computers in a distributed manner.

Note that embodiments of the present disclosure are not limited to the embodiments described above, and various modifications may be made without departing from the scope of the present disclosure. Furthermore, the effects described herein are merely examples and are not limited, and other effects may be provided.

Furthermore, the present disclosure may have the following configurations.

(1)

A transmission device including:
a generation unit that generates physical layer control information, the physical layer control information being included in a physical layer frame; and
a transmission unit that transmits the physical layer frame as a broadcast signal to which a layered division multiplexing method is applied, in which
the physical layer control information includes a compressed pointer obtained by compressing a pointer that indicates a position of the first error correction code block in the physical layer frame and is expressed by an integer multiple of the greatest common divisor of possible values of the pointer.

(2)

The transmission device according to the above (1), in which
a broadcast signal under a first broadcasting method is transmitted in a first layer of the layered division multiplexing method, and a broadcast signal under a second broadcasting method different from the first broadcasting method is transmitted in a second layer, and
the physical layer control information includes the number of segments used under the second broadcasting method among a plurality of segments.

(3)

The transmission device according to the above (2), in which
the first layer includes a high power layer,
the second layer includes a low power layer, and
the second broadcasting method includes a next-generation method of the first broadcasting method.

(4)

The transmission device according to the above (2) or (3), in which
the physical layer control information includes information indicating whether or not an adjustment band is placed in a guard band, the adjustment band being used to transmit the broadcast signal under the second broadcasting method.

(5)

The transmission device according to the above (1), in which
the physical layer frame includes an OFDM frame,
the error correction code block includes an FEC block, and
the pointer includes an FEC block pointer.

(6)

The transmission device according to the above (1) or (5), in which
the physical layer control information includes a TMCC signal.

(7)

A transmission method including:
causing a transmission device to generate physical layer control information, the physical layer control information being included in a physical layer frame; and
causing the transmission device to transmit the physical layer frame as a broadcast signal to which a layered division multiplexing method is applied, in which
the physical layer control information includes a compressed pointer obtained by compressing a pointer that indicates a position of the first error correction code block in the physical layer frame and is expressed by an integer multiple of the greatest common divisor of possible values of the pointer.

(8)

A reception device including a reception unit that receives a physical layer frame transmitted as a broadcast signal to which a layered division multiplexing method is applied, in which
the physical layer frame includes physical layer control information including a compressed pointer obtained by compressing a pointer that indicates a position of the first error correction code block in the physical layer frame and is expressed by an integer multiple of the greatest common divisor of possible values of the pointer, and
the reception unit performs error correction decoding for each error correction code block included in the physical layer frame on the basis of the compressed pointer obtained from the physical layer control information.

(9)

The reception device according to the above (8), in which
a broadcast signal under a first broadcasting method is transmitted in a first layer of the layered division multiplexing method, and a broadcast signal under a second broadcasting method different from the first broadcasting method is transmitted in a second layer, and
the physical layer control information includes the number of segments used under the second broadcasting method among a plurality of segments.

(10)

The reception device according to the above (9), in which
the first layer includes a high power layer,
the second layer includes a low power layer, and
the second broadcasting method includes a next-generation method of the first broadcasting method.

(11)

The reception device according to the above (9) or (10), in which
the physical layer control information includes information indicating whether or not an adjustment band is placed in a guard band, the adjustment band being used to transmit the broadcast signal under the second broadcasting method.

(12)

The reception device according to the above (8), in which
the physical layer frame includes an OFDM frame, the error correction code block includes an FEC block, and
the pointer includes an FEC block pointer.

(13)

The reception device according to the above (8) or (12), in which
the physical layer control information includes a TMCC signal.

(14)

A reception method including causing a reception device to receive a physical layer frame transmitted as a broadcast signal to which a layered division multiplexing method is applied, in which
the physical layer frame includes physical layer control information including a compressed pointer obtained by compressing a pointer that indicates a position of the first error correction code block in the physical layer frame and is expressed by an integer multiple of the greatest common divisor of possible values of the pointer, and
error correction decoding is performed for each error correction code block included in the physical layer frame on the basis of the compressed pointer obtained from the physical layer control information.

### REFERENCE SIGNS LIST

Transmission device
Reception device
101 Generation unit
102 Transmission unit
201 Reception unit
202 Processing unit
1001 CPU

1. A transmission device comprising:
a generation unit that generates physical layer control information, the physical layer control information being included in a physical layer frame; and
a transmission unit that transmits the physical layer frame as a broadcast signal to which a layered division multiplexing method is applied, wherein
the physical layer control information includes a compressed pointer obtained by compressing a pointer that indicates a position of a first error correction code block in the physical layer frame and is expressed by an integer multiple of a greatest common divisor of possible values of the pointer.

2. The transmission device according to claim 1, wherein
a broadcast signal under a first broadcasting method is transmitted in a first layer of the layered division multiplexing method, and a broadcast signal under a second broadcasting method different from the first broadcasting method is transmitted in a second layer, and
the physical layer control information includes a number of segments used under the second broadcasting method among a plurality of segments.

3. The transmission device according to claim 2, wherein
the first layer includes a high power layer,
the second layer includes a low power layer, and
the second broadcasting method includes a next-generation method of the first broadcasting method.

4. The transmission device according to claim 2, wherein
the physical layer control information includes information indicating whether or not an adjustment band is placed in a guard band, the adjustment band being used to transmit the broadcast signal under the second broadcasting method.

5. The transmission device according to claim 1, wherein
the physical layer frame includes an OFDM frame,
the error correction code block includes an FEC block, and
the pointer includes an FEC block pointer.

6. The transmission device according to claim 1, wherein
the physical layer control information includes a TMCC signal.

7. A transmission method comprising:
causing a transmission device to generate physical layer control information, the physical layer control information being included in a physical layer frame; and
causing the transmission device to transmit the physical layer frame as a broadcast signal to which a layered division multiplexing method is applied, wherein
the physical layer control information includes a compressed pointer obtained by compressing a pointer that indicates a position of a first error correction code block in the physical layer frame and is expressed by an integer multiple of a greatest common divisor of possible values of the pointer.

8. A reception device comprising a reception unit that receives a physical layer frame transmitted as a broadcast signal to which a layered division multiplexing method is applied, wherein
the physical layer frame includes physical layer control information including a compressed pointer obtained by compressing a pointer that indicates a position of a first error correction code block in the physical layer frame and is expressed by an integer multiple of a greatest common divisor of possible values of the pointer, and
the reception unit performs error correction decoding for each error correction code block included in the physical layer frame on a basis of the compressed pointer obtained from the physical layer control information.

9. The reception device according to claim 8, wherein
a broadcast signal under a first broadcasting method is transmitted in a first layer of the layered division multiplexing method, and a broadcast signal under a second broadcasting method different from the first broadcasting method is transmitted in a second layer, and
the physical layer control information includes a number of segments used under the second broadcasting method among a plurality of segments.

10. The reception device according to claim 9, wherein
the first layer includes a high power layer,
the second layer includes a low power layer, and
the second broadcasting method includes a next-generation method of the first broadcasting method.

11. The reception device according to claim 9, wherein
the physical layer control information includes information indicating whether or not an adjustment band is placed in a guard band, the adjustment band being used to transmit the broadcast signal under the second broadcasting method.

12. The reception device according to claim 8, wherein
the physical layer frame includes an OFDM frame,
the error correction code block includes an FEC block, and
the pointer includes an FEC block pointer.

13. The reception device according to claim 8, wherein
the physical layer control information includes a TMCC signal.

14. A reception method comprising causing a reception device to receive a physical layer frame transmitted as a broadcast signal to which a layered division multiplexing method is applied, wherein
the physical layer frame includes physical layer control information including a compressed pointer obtained by compressing a pointer that indicates a position of a first error correction code block in the physical layer frame and is expressed by an integer multiple of a greatest common divisor of possible values of the pointer, and
error correction decoding is performed for each error correction code block included in the physical layer frame on a basis of the compressed pointer obtained from the physical layer control information.
